(19) United States
(12) Patent Application Publication
(10) Pub. No.: US 2010/0231350 A1
(43) Pub. Date: Sep. 16, 2010

(54) MECHATRONIC FURNITURE LOCK

(76) Inventors: Alexander Scharer, Gumligen (CH); Kaspar Stockli, Kiesen (CH); Stefan Krenger, Thun (CH)

Correspondence Address: BIRCH STEWART KOLASCH & BIRCH, PO BOX 747, FALLS CHURCH, VA, 22040-0747, US

(21) Appl. No.: 12/738,508

(22) PCT Filed: Sep. 25, 2008
(86) PCT No.: PCT/CH08/00395

§ 371 Date: Apr. 16, 2010

(30) Foreign Application Priority Data
Oct. 18, 2007 (EP) 07405311.7

(51) Int. Cl. G06F 7/04; E05B 65/00; E05B 47/08; E05B 65/46

(52) U.S. Cl. 340/5.2; 70/57; 70/275; 70/86

(57) ABSTRACT

The invention relates to a mechatronic lock comprising a linearly movable bolt which can be moved from a retracted position into an advanced position in order to lock the lock. Said lock further comprises an actuating element for manually actuating the bolt, a blocking element which can laterally engage into a profiled section of the bolt in order to block the linear movement of the bolt in the advanced position of the bolt, and an electric drive for moving a movable intermediate element. The blocking element can be actuated by the movable intermediate element via a first spring means, especially a coil spring, in such a way that the spring means can be biased by actuating the drive when the bolt is in the retracted position. The blocking element thus snaps into the advanced position thereof in the profiled section of the bolt when the bolt is advanced, and the bolt is prevented from being retracted. Also described is an arrangement comprising at least two furniture compartments that are each fitted with a mechatronic lock. Said arrangement further comprises at least two individually encodable transponders for opening the locks, a central control device, and a network via which data can be transmitted between the central control device and the locks.

### TECHNICAL FIELD

The invention relates to a mechatronic lock, in particular to a furniture lock, having a linearly moving bolt which can be moved from a pulled-back position to a pushed-forward position in order to lock the lock, and an operating element for manual operation of the bolt.

### PRIOR ART

Mechatronic locks are known. They comprise a mechanical part which, in particular, comprises a moving locking element, as well as an electronic part, which controls the opening and locking of the lock. Mechatronic locks have a number of advantages. For example, inter alia, they allow wire-free unlocking of the lock, for example by using active or passive transponders which send data to the lock and can be read by the lock. Furthermore, they allow flexible adaptation of the locking system, in that authorizations to open a lock can be changed in a simple manner electronically in the lock and/or in the transponder.

DE 38 42 569 C2 (Geze GmbH) discloses a locking apparatus for locking and unlocking doors and windows having a bolt which can be operated electrically and manually via an emergency operating device. In this case, the bolt is acted on under the influence of a spring to the locked position, and interacts with an electric motor, in that the bolt is held in contact with an output-drive element of the electric motor under the influence of the spring during electric-motor locking and unlocking. Since the bolt coupling is assisted via the spring, this bolt can furthermore operate with a snap action, that is to say the locked position can be selected even before the door reaches the closed position.

DE 100 21 839 A1 (Lehmann Vertriebsgesellschaft mbH) relates to an electronic furniture lock having an electrically operable locking apparatus which has a linear blocking slide. The apparatus comprises a reversible rotation-direction direct-current motor which acts on a buffer spring which allows the locking apparatus and the furniture closure apparatus to be operated independently of one another, and the two apparatuses interact only when the blocking slide is sufficiently prestressed by means of the buffer spring and against the force of a restraint spring. The rotary movement of the motor is translated to a linear movement of the blocking slide via a rotation body with a cam track and a blocking slide element which is guided in the cam track. The spring force of the buffer spring is greater than the spring force of the restraint spring. In one embodiment, a blocking bolt is used, by means of which a blocking catch can be blocked.

The known mechatronic locks often have a complicated mechanical design, and make intuitive operation of the lock more difficult.

### DESCRIPTION OF THE INVENTION

The object of the invention is to provide a mechatronic lock which is associated with the technical field mentioned initially, is of simple design and can be operated and used largely in the same way as conventional mechanical locks.

The achievement of the object is defined by the features of claim 1. According to the invention, the lock comprises a blocking element which can engage at the side in a profile on the bolt in order to block the linear movement of the bolt in the pushed-forward position of the bolt, as well as an electrical input drive for movement of a moving intermediate element. The blocking element can be operated via a first spring means, in particular via a helical spring, by the moving intermediate element such that the spring means can be prestressed by operation of the input drive with the bolt pulled back, such that, when the bolt is pushed forward to its pushed-forward position, the blocking element snaps into the profile on the bolt, and prevents the bolt from being pulled back.

Since the bolt is operated manually and the blocking of the bolt is achieved only indirectly electrically, the lock can be operated largely intuitively, that is to say in a similar manner to conventional locks. The blocking means can be prestressed against the bolt by the spring means. In conjunction with the profile on the bolt, it is therefore possible to prepare a closing process of the blocking means independently of the time of operation of the bolt, which leads to high energy efficiency of the electrical input drive and—at a later point in time as well—allows simple and quick locking of the lock without the input drive having to be operated. The profile may in this case be in the form of an outward bulge, an incision, or may be in a projecting form, for example in the form of a tab on the bolt.

Since the bolt is designed such that it can be moved linearly, it can be moved by a simple linear movement out of the lock into a mating piece, and can be moved back out of the latter. This allows the lock and the mating piece which interacts with it to be designed to be simple. The lock bolt interacts with a mating piece which, for example, is firmly fitted to a door frame, a furniture item or a further door.

In principle, electrically operable input drives are known and are commercially available. By way of example, they are based on electromagnets, micromotors or piezoceramic elements.

The intermediate element advantageously comprises an input-drive part which can be moved by operation of the input drive, and an output-drive part, which is mounted on the input-drive part via a second spring means, in particular via a helical spring, such that the second spring means is stressed by operation of the input drive when the blocking element is jammed in the profile on the bolt by pulling the blocking element back when the bolt is released.

The output-drive part is itself coupled to the blocking element, which interacts with the profile on the bolt when the bolt is in the closed state. If the bolt is actually pulled back during the process of opening the lock, before the blocking element has been pulled completely back out of the corresponding profile, it is possible for the blocking element to be briefly jammed in the profile. In this situation, the operation of the electrical input drive moves the input-drive part, and thus stresses the helical spring. As soon as the blocking element and therefore the output-drive part can move, for example because the user briefly reduces the force on the bolt, the stressed second spring means pulls the output-drive part back, at the same time that the blocking element is also pulled back out of the profile. The electrical input drive therefore cannot directly release the blocking element by means of the clamping force which occurs between the profile and the blocking element, which is coupled to the output-drive part. The block is not released until the clamping force between the profile and the blocking element has decreased.

It is also possible to dispense with a feature such as this. It is also possible for the input drive to act directly on the output-drive part, or to act on it only via the input-drive part, without having to use a spring in the process, which stores the work carried out by the input drive, and transmits it to the output-drive part as soon as the latter is not clamped in. The intermediate element may also be formed integrally, as a result of which the movement of the input drive is transmitted directly to the blocking element. In this case, the input drive can be controlled such that the force with which it drives the intermediate element is limited such that the input drive operates only when a blocking element is not clamped in.

The input drive is advantageously formed by an electric motor with a rotating shaft. The intermediate element can in this case be moved by rotation of the rotating shaft via a transmission. An electric motor can be controlled reliably and precisely by electronics, and can therefore be used as an input drive for the intermediate element. The rotation of the rotating shaft of the electric motor is in this case transmitted by a transmission to the intermediate element, which can be moved by this rotary movement. A transmission such as this allows the intermediate element to be controlled precisely, in addition to providing a simple technical implementation of the input drive.

Other input drives, for example a linear actuator, can also be used as an input drive, instead of an electric motor.

In one preferred embodiment of the lock, the input-drive part of the intermediate element is a threaded sleeve, which interacts with a profiled output shaft of the transmission via an external profile which is connected in a rotationally fixed manner thereto.

The threaded sleeve is mounted via its thread such that it can rotate, as a result of which the transmission of a rotary movement from the output shaft of the transmission to the external profile on the threaded sleeve results in linear movement of the threaded sleeve. By way of example, the interaction between the output shaft and the threaded sleeve can be achieved by a tooth system, in the sense of a gearwheel transmission. In this case, the output shaft of the transmission may be the rotating shaft of the electric motor itself or a shaft which is driven by this shaft and whose rotation is stepped up or down. In the case of a multi-part intermediate element, the threaded sleeve can form the input-drive part, whose linear movement is transmitted by the second spring element to the output-drive part of the intermediate element.

Alternatively, the intermediate element can also be driven in a different manner, for example without using a threaded sleeve or by an input-drive belt or a friction-locking connection, which does not require any mutually matched profile on the threaded sleeve and the output shaft of the transmission.

The blocking element is advantageously formed by a linearly movable blocking bolt. A blocking bolt can be coupled to the intermediate element particularly easily and therefore offers a particularly simple option for a lock according to the invention. A blocking bolt such as this can be connected to the intermediate element via the first spring means. In the case of a linearly moving intermediate element, the blocking bolt can be moved linearly, and can engage in the profile on the bolt, in the same manner.

It is also possible for the blocking element to be in a different form. For example, the blocking element can be formed by a lever which is attached such that it can rotate or pivot and can be moved backward and forth by the intermediate element between a locked position, in which it engages in the profile on the bolt, and an unlocked position, in which it releases the profile on the bolt.

In one preferred embodiment, the input-drive part and the output-drive part of the intermediate element, the blocking bolt as well as the first and the second spring means are arranged on the same axis. An arrangement such as this of the parts of the intermediate element and of the blocking bolt as well as the spring means results in particularly simple force transmission because a linear movement of the input-drive part is transmitted via the second spring element to the output-drive part of the intermediate element, and from this, via the first spring element to the blocking element. If the spring elements are in the form of helical springs, this linear force transmission can be achieved particularly easily.

Alternatively, it is also possible for the input-drive part and the output-drive part of the intermediate element, the blocking element and the first and second spring elements not to be arranged on the same axis. Transmission mechanisms other than directly linearly acting transmission mechanisms may necessitate an arrangement such as this of said components.

In one preferred embodiment of the lock, the output-drive part is guided movably in the threaded sleeve and extends from that side of the threaded sleeve which faces away from the blocking bolt to that side of the threaded sleeve which faces the blocking bolt. A compression spring is arranged as the second spring element between the threaded sleeve and an end of the output-drive part facing away from the blocking bolt. A stop ring is arranged between the threaded sleeve and an end of the output-drive part which faces the blocking bolt. Furthermore, that end of the output-drive part which faces the blocking bolt acts on the first spring means.

The movable guidance of the output-drive part in the threaded sleeve allows sprung force transmission between the threaded sleeve, which is coupled to the input drive, and the output-drive part. This force transmission in a first direction, which is used to unlock the lock, takes place via the compression spring on the side which is averted from the blocking bolt and forms the second spring element. A movement of the threaded sleeve relative to the output-drive part of the intermediate element in the first direction leads to pressure being applied to the compression spring, which passes the pressure onto the output-drive part. When the input-drive part is moved in the opposite direction, it acts on a stop ring, which transmits the movement directly to the output-drive part. The output-drive part itself presses on the first spring element, which thus exerts force on the blocking bolt. If the blocking bolt can move in the respective direction, operation of the input drive therefore leads to linear movement of the blocking bolt. If the blocking bolt cannot move, because the profile on the bolt is not accessible or because the blocking bolt has jammed in the profile, one of the two spring means is prestressed by operation of the input drive.

Alternatively, it is also possible for the threaded sleeve and the output-drive part of the intermediate element to be firmly connected to one another, or for the sleeve to be mounted such that it can rotate but cannot be moved linearly on the output-drive part. The output-drive part and the threaded sleeve, as well as the second spring element, may also be arranged differently.

By way of example, the threaded sleeve can be mounted on the output-drive part of the intermediate element such that the second spring element couples the threaded sleeve to the output-drive part on the side facing the blocking bolt.

In a further preferred embodiment, the operating element can be rotated for operation of the bolt. A rotatable operating element, for example a rotary knob, a door catch, a lever or a latch, represents an element which can be operated easily and intuitively.

Alternatively, the operating element may also, for example, be in the form of a linearly movable handle. By way of example, a linearly movable handle also allows the bolt to be operated directly.

The operating element is advantageously coupled to the bolt by a toothed-rod input drive, wherein the toothed-rod input drive is formed by a first gearwheel-like tooth system on the operating element side and by a toothed-rod-like tooth system which permanently interacts therewith and is on the bolt side. This results in the rotary movement of the operating element being converted to the linear movement of the bolt.

A toothed-rod input drive such as this offers a reliable coupling, which can be implemented technically easily, between a rotatable operating element and a linearly movable bolt. Furthermore, the toothed-rod input drive can provide a transmission function.

The tooth system on the operating element side is advantageously formed on the rotatable operating element itself, and the tooth system on the bolt side is advantageously formed directly on the bolt. The function according to the invention can therefore be achieved with a minimum number of parts, creating a low-loss, mechanically robust, connection between the operating element and the bolt.

Alternatively, the operating element can interact with the bolt in some other manner. The tooth system on the operating element side and/or the tooth system on the bolt side can be arranged on a rotatable element arranged downstream from the operating element, or on a linearly moving element which is arranged upstream of the bolt. For example, it is possible for the operating element to be connected to the bolt by a lever mechanism. Instead of being like a toothed rod, the coupling device may also be designed differently, for example by forming studs on the rotatable operating element or on a downstream rotating element, which make contact with the bolt or with an upstream linearly moving element, or by using a toggle lever, which is mounted eccentrically on the rotatable operating element. In addition, it is also possible to provide a step-up or step-down transmission as well between the gearwheel-like tooth system on the operating element side and the toothed-rod-like tooth system on the bolt side.

The lock can advantageously be opened only when an appropriately coded transponder is moved into a reception area of the lock. An embodiment of the lock such as this allows keyless identification of a person who is authorized to open the lock. In addition to the simplification resulting from the lack of any need for a key having to be mechanically engaged with the lock, a transponder furthermore allows categorization of different users. For example, users or user groups can be individually identified. Such identification of users or user groups leads to the capability, for example, for only specific, selected users to be able to unlock the lock, or for the lock to be released or to be locked as a function of a time of day or a day of the week.

Solutions for wire-free transmission of identification data are known in principle under the name RFID (radio-frequency identification). Both active and passive transponders can be used for the purposes of the invention. Active transponders are distinguished by being able to emit signals, for example RF signals or infrared signals, which can be received by the lock receiver. Passive transponders comprise elements which can be read contactlessly, for example inductively or capacitively, by the lock receiver when they are in the vicinity of the receiver. When identification signals which are associated with an authorized user are transmitted from the transponder to the receiver, the controller operates the input drive, as a result of which the operating element or the bolt, or the coupling mechanism is released and the bolt can be pulled back.

Alternatively, it is also possible to dispense with a transponder such as this. By way of example, the blocking element can also be unlocked, and the bolt released, by entering a code on a keypad, or simply by pushing a button.

For use with an active transponder, a lock according to the invention can be equipped with a transmitter which can emit an activation signal in order to activate the active transponder to emit an identification signal. There is therefore no need for the active transponder itself to emit signals permanently or at a rapid rate in order to ensure that, when approaching a lock, this lock detects its presence and if appropriate allows the lock to be opened. The transponder receiver just needs to be in a standby mode in order to allow it to receive any activation signals from a lock. This massively reduces the power consumption of the transponder.

Alternatively, it is possible to use a transponder with a control element, for example a pushbutton, which emits an identification signal only when the control element is operated by the user. In a further embodiment, the transponder sends identification signals continuously or at a predetermined time interval (for example 0.1-0.5 s). In order to reduce the power consumption, the transponder can be switched off manually; furthermore, it may comprise a movement sensor, as a result of which the emission of the signal can be interrupted after a certain time interval (for example of about 30 s) during which the transponder has not moved. After detection of a new movement, the emission of the identification signal is resumed.

The lock advantageously has a control element, in particular a pushbutton, by means of which the transmitter can be activated to emit the activation signal or to read passive transponders. A pushbutton such as this makes it possible to avoid the transmitter emitting appropriate signals continuously or at short intervals, and thus consuming an unnecessarily large amount of energy. In this case, it is both feasible for operation of the control element, for example by pushing on the pushbutton, to lead to emission of a single activation signal, or else for the operation of the control element to result in continuous or regularly repeated emission of the activation signal over a specific time period.

Alternatively, the transmitter can also emit the activation signal continuously or at regular intervals, and this does not require any appropriate control element.

In one preferred embodiment, the control element is in the form of a pushbutton which is arranged in a rotating shaft of the rotatable operating element. This embodiment of the control element allows particularly intuitive control. A user who is operating the operating element can therefore unlock the lock by previously pressing the pushbutton which is fitted to the operating element.

Alternatively, the control element can also be designed differently. On the one hand, it is possible for the control element not to be formed by a pushbutton, while on the other hand the pushbutton or the control element that is designed in some other way can be arranged at a different location than in the rotating shaft of the rotatable operating element. In this case, in particular, it is possible to arrange the control element adjacent to the operating element. The operating element can also be designed such that it acts as a control element at the same time, for example by having a small amount of freedom of movement about its rotation axis, or by the entire operating element being axially movable (and therefore at the same time itself acting as a pushbutton).

The lock advantageously has a controller which controls the lock such that the electrical input drive is operated automatically after a predetermined time interval after an opening process of the blocking bolt, such that, depending on the position of the bolt, the blocking element is moved forward and the first spring means is stressed. This ensures that the lock is locked again after the bolt has been closed. In this case, thanks to the first spring element, it is not important whether the bolt is in the locked position or in the open position at the time when the electrical input drive is operated. If the bolt is in the open position, and the blocking element, which is driven by the electrical input drive via the intermediate element, cannot interact with the profile on the bolt, the spring element exerts stress on the blocking element. The stressing of the spring element onto the blocking element is released as soon as the bolt assumes the locked position and the blocking element interacts with the profile on the bolt, that is to say snaps into the profile. As well as additional security of this embodiment by the automatic blocking of the bolt, this embodiment also does not require any further operating or control element to actively cause the bolt to be blocked.

Alternatively, it is also possible to dispense with the controller for automatic operation of the electrical input drive. It is also possible for the controller to block the bolt automatically, for example on the basis of the bolt position.

In a preferred embodiment, the lock is provided with sensors by means of which an instantaneous position of the blocking bolt can be detected. By way of example, a sensor such as this may be formed by a limit switch which is activated in one or in both intended limit positions of the blocking bolt. This depends on identification of whether the lock is locked, that is to say whether the bolt is blocked, or whether the bolt is unlocked, that is to say it can be opened. One or more such sensors is or are particularly worthwhile in an embodiment in which the electrical input drive is coupled to the blocking bolt via a spring element. This is because, in an embodiment such as this, it is not possible to close clearly from the position of the input drive to the position of the blocking bolt, as a result of which a detector for the input-drive position is not suitable for detection of the blocking bolt position. The information as to whether the bolt is blocked or released may, however, be of major interest, for example when the aim is to record the opening and closing processes or when the status of a lock according to the invention is transmitted in real time to a central facility.

Alternatively, it is also possible to dispense with sensors. There is no need per se for the functionality of the lock for sensors to identify whether the lock is locked or unlocked.

The power for the electrical input drive, the controller and, where appropriate, the receiver, is advantageously supplied independently of the mains, for example by a long-life battery. In principle, the energy which the user applies to open the lock can also be recovered, and can be used to charge a rechargeable battery, or a suitable capacitor. In order to allow the furniture item to be opened without any problems even when the battery is dead, the lock according to the invention may have an externally accessible supply connection which allows electrical energy to be fed to the lock. A commercially available supply unit or a supply unit designed specifically for the lock according to the invention can then be connected to this supply connection, after which the lock can be operated in the normal manner. The battery is advantageously easily accessible, such that it can be replaced, once the lock has been opened. The supply unit may itself be mains-powered or battery-powered. The supply connection on the mechatronic lock is expediently covered, for example by a cap, when not in use.

Alternatively, the electrical input drive, the controller and, if appropriate, the receiver as well may be fed from an external energy source. For this purpose, by way of example, the lock may be connected to an external electrical mains system or to an external battery.

Particularly if the battery-powered lock does not have an externally accessible supply connection, the lock advantageously has a device for measurement of a battery voltage, and is controlled such that an alarm signal is sounded when a predetermined first battery voltage is undershot, and that, after undershooting a predetermined second battery voltage, which is lower than the first battery voltage, the lock can then be opened only by a specifically coded transponder.

In order to allow a critical state of charge of the battery to be indicated in good time, the measurement device checks the charge stored in the battery. The alarm signal which is sounded when a predetermined first battery voltage is undershot makes the user aware that the battery must be replaced soon, in order to ensure uninterrupted, problem-free opening of the lock. When a predetermined second battery voltage has been undershot, which is lower than the first battery voltage, then the lock restricts its operability in a controlled manner. The restricted operability comprises the capability to open the lock only by means of specifically coded transponders. By way of example, these are issued to a specific group of people, for example to the maintenance service. The lock can therefore still be opened only by those people who are also able to replace the battery without delay. This makes it possible to prevent the lock from being operated to below the critical battery voltage, down to which the electrical input drive can still be operated by the battery.

Alternatively, the users who can still operate the lock below the predetermined second battery voltage can also be selected by a specific, manually entered, identification code. In principle, it is furthermore also possible for the lock to be operated without a device for measurement of a battery voltage and without the mechanisms introduced with the aid of this device.

The lock is particularly suitable for furniture items and is arranged, for example, in or on a door, flap or drawer. In one particularly preferred embodiment of the invention, the lock is held between an outer wall and an inner wall of a door of the furniture item. The outer wall and inner wall are in this case arranged at a distance from one another and are manufactured from relatively thin material, for example from sheet metal, as a result of which there is space for the lock or a major part thereof between the walls.

The use of a mechatronic, in particular of a lock according to the invention, arranged in a plurality of furniture compartments allows the lock system to be managed and/or monitored centrally. To this end, the arrangement comprises:
a) at least two furniture compartments, wherein each of the furniture compartments comprises at least one mechatronic lock;
b) at least two transponders for opening the locks, wherein a first identification code can be allocated to a first of the transponders, and a second identification code which is not the same as the first identification code, can be allocated to a second of the transponders;
c) a central control device;
d) a network via which data can be transmitted between the central control device and the locks.

In this case, the individual furniture compartments may be accommodated in the same furniture item and/or in a plurality of furniture items. The lock according to the invention is particularly preferably used in conjunction with a furniture system having a plurality of furniture items, wherein the furniture items may each have a mechatronic lock according to the invention, or else a plurality of furniture compartments with separate mechatronic locks. The network is advantageously implemented without the use of wires, for example based on known wire-free protocols such as WLAN or Bluetooth. By way of example, the central control device may be formed by a conventional personal computer (PC) with appropriate receivers. Depending on the purpose of the central control device, data flows from the control device to the locks (for example in order to vary the locking plan), and/or in the opposite direction (for example in order to monitor the lock operating processes). The different identification codes are used to distinguish between different users of the furniture system, thus making it possible to create customized locking plans and to record user-related information about the use of the furniture system.

The central control device may comprise an authorization database, in which associations between identification codes and authorizations for opening the locks can be stored, thus allowing central management of the authorizations. The authorizations for opening the locks can also be stored on a differentiated basis in this authorization database. For example, it is feasible to allow specific user groups to open the locks only in predetermined time intervals, for example during specific office times or on specific days of the week.

Alternatively or additionally, the central control device may also comprise an access database, in which associations between identification codes and opening processes of the locks can be stored, so as to allow evaluation of the opening movements with respect to a plurality of users. Time information can also be stored in the database, in addition to the identification codes and the details relating to the respectively operated lock. In addition to the general evaluation of the opening movements, an association can also take place, and be stored, between individual identification codes and opening processes. Personalized usage statistics and usage monitoring are therefore also possible.

The access database makes it possible to use the furniture system according to the invention for recording the use of a working environment. The following steps are carried out for this purpose:
a) Transponders for opening the locks are issued to users of the working environment, with different identification codes being allocated to different transponders.
b) During opening processes, the respective identification code of the transponder is recorded by the mechatronic lock that has been opened.
c) The recorded identification code is then sent to a central database.
d) The association between the lock and the identification code is then stored in the central database.

The stored associations (possibly with time information added to them) can be used to determine which users have used which furniture compartments when and how often, for example in order to obtain or return documents or files. The working environment can then be optimized on the basis of the corresponding data, for example by placing documents, files or entire furniture items with contents differently, or by allocating office spaces differently to the users. In addition to the furniture system, further information transmitters and/or receivers can be included, for example time recording systems, computer installations or specific recording facilities, which, for example, determine which rooms are used by which users at what times.

Further advantageous embodiments and feature combinations of the invention will become evident from the following detailed description and from the totality of the patent claims.

### BRIEF DESCRIPTION OF THE DRAWINGS

The drawings, which will be used to explain the exemplary embodiment, show:

FIG. 1 shows a plan view of an unencapsulated lock according to the invention, in the closed position with the intermediate element not stressed;

FIG. 2 shows a plan view of the unencapsulated lock in the open position, with the intermediate element unstressed;

FIG. 3 shows a plan view of the unencapsulated lock in the closed position, with the intermediate element prestressed;

FIG. 4 shows a plan view of the unencapsulated lock in the open position, with the intermediate element prestressed;

FIG. 5 shows a cross-sectional illustration of the lock;

FIG. 6 shows a furniture door with a lock installed;

FIG. 7 shows a perspective drawing of the lock according to the invention;

FIG. 8 shows a block diagram of a lock according to the invention and of its communication with a transponder; and

FIG. 9 shows a block diagram of a furniture system with a lock installation according to the invention.

In principle, the same parts are provided with the same reference symbols in the figures.

### APPROACHES TO IMPLEMENTATION OF THE INVENTION

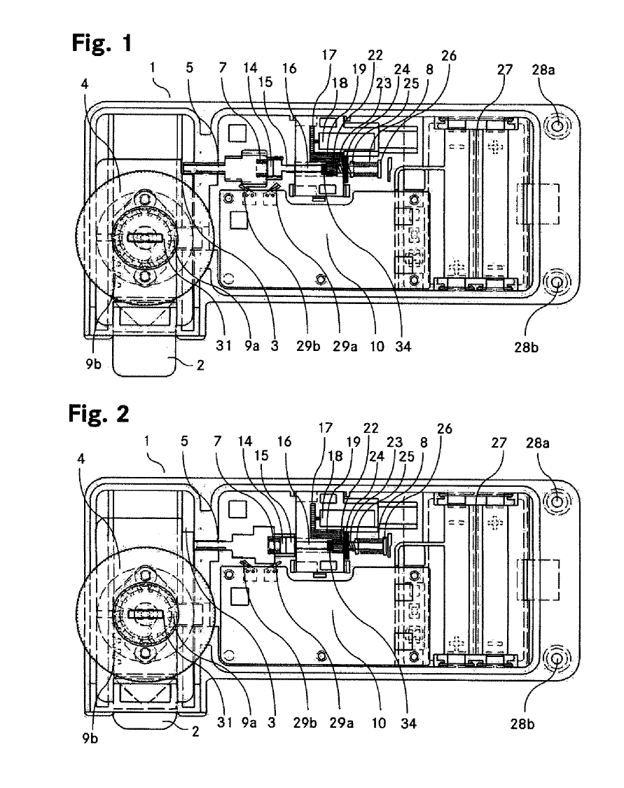

FIG. 1 shows a plan view of a lock 1 according to the invention. The lock 1 is unencapsulated, that is to say the lock housing cover has been removed in this illustration. The blocking mechanism for the bolt 2 can therefore be seen. The bolt 2 is in the closed position, that is to say the position in which it is pushed forward with respect to the housing, and in this position is locked by a blocking bolt 5, which engages in a profile 3 in the bolt 2. The bolt 2 is rectangular and has a toothed rod 9b. The toothed rod 9b interacts with a gearwheel 9a, which is connected in a rotationally fixed manner to a manually operable rotating handle 4. The rotating handle 4 is round in shape and, in its center, has an externally operable pushbutton 31.

The pushbutton 31 in the illustrated embodiment is used to activate the opening mechanism. By way of example, pushing the pushbutton 31 changes the lock from a switched-off or standby mode to a receiving mode. By way of example, a signal is thus emitted which activates an active transponder or reads a passive transponder. If the lock finds that a transponder of a person who is authorized to open the lock is within a reception area of the lock, the bolt 2 is released.

Rotating the rotating handle 4 likewise results in the gearwheel 9a that is connected to it rotating. This in turn interacts with the toothed rod 9b, which itself moves the bolt 2 between the pushed-forward closed position and the pulled-back open position. In this case, the housing of the bolt 2 is designed such that the bolt 2 can be pulled completely back into the housing. The profile 3 on the bolt 2 is in this case in the form of a side inward bulge into the bolt 2. In the pushed-forward closed position, the blocking bolt 5 can engage in the profile 3 on the bolt 2, thus preventing the bolt 2 from being pulled back into the housing. The front end of the front section of the blocking bolt 5, which is in the form of a pin, is for this purpose moved at right angles to the movement direction of the bolt 2, into the profile 3.

The mechanism for blocking the bolt 2 is moved by an electrical input drive 18. The electrical input drive 18 is formed by an electric motor, on whose input drive shaft a gearwheel 17 is arranged. The gearwheel 17 itself drives a further gearwheel 19, with the input drive shaft and the axis of the further gearwheel 19 running parallel to one another. The further gearwheel is cylindrical, with the height of the cylinder, that is to say the extent of the gearwheel 19 along its axis, being greater than the diameter of the gearwheel 19. The gearwheel 19 drives a threaded spindle via an external profile 22.

The threaded spindle comprises a first part with an external profile 22, and a second part with an external thread 23. The external profile 22 in this case interacts with the gearwheel 19 and therefore transmits the rotary movement of the electrical input drive 18 via the further, elongated gearwheel 19, to the threaded spindle. The external thread 23 on the threaded spindle interacts with an internal thread 24, which is arranged fixed to the housing of the lock 1. The rotary movement which is transmitted via the external profile 22 to the threaded spindle results in the threaded spindle being screwed along an axis, which is parallel to the axis of the further gearwheel 19, by the interaction of the external thread 23 with the internal thread 24 on the housing. In this case, the elongated extent of the gearwheel 19 ensures that the external profile 22 on the threaded spindle always interacts with the gearwheel 19 such that a rotary movement of the gearwheel 19 is transmitted to the threaded spindle.

An output-drive part 16 in the form of a pin is mounted in the threaded spindle such that it can move. The longitudinal axis of the output-drive part 16 in this case coincides with the axis along which the threaded spindle moves during rotation. The threaded spindle surrounds the output-drive part 16 in an annular shape, and thus forms a journal bearing, in which the output-drive part 16 can move freely independently of the rotary movement of the threaded spindle. Furthermore, a stop ring 34, which limits axial movement of the threaded spindle in the direction of the blocking bolt, is mounted on the output-drive part 16, on the side of the threaded spindle facing the blocking bolt. During an axial movement of the threaded spindle in this direction, the stop ring 34 causes the output-drive part 16 to directly follow the movement of the threaded spindle. In addition to the first part with the external profile 22 and the second part with the external thread 23, the threaded spindle also has a first plate 25, which likewise surrounds the output-drive part 16 in an annular shape, on the side that is averted from the blocking bolt. The first plate 25 has an axial contact surface, on which a helical spring 8 rests, which helical spring 8 likewise surrounds the output-drive part 16 in an annular shape. In this case, the helical spring 8 is located between the first plate 25, which is part of the threaded spindle, and a second plate 26, which is firmly connected to that end face of the output-drive part 16 which is averted from the blocking bolt.

An axial movement of the threaded spindle in the direction of the second plate 26 results in the helical spring 8 being compressed between the first plate 25 and the second plate 26, thus transmitting a force from the threaded spindle to the output-drive part 16. If the output-drive part 16 can move freely, it follows the movement of the threaded spindle directly. If it cannot move so freely that it can directly follow the movement of the threaded spindle, the helical spring 8 is compressed. When the output-drive part 16 is released again, the stressed helical spring 8 results in the output-drive part 16 being moved axially away from the bolt, provided that the threaded spindle has not been moved back in the meantime, with the spring 8 having had the stress removed from it again.

The movement of the threaded spindle just described, during the course of which the spring 8 is compressed, corresponds to the movement for pulling back the blocking bolt 5 out of the profile 3, and therefore for releasing the bolt 2. The blocking bolt 5 is in this case moved by the output-drive part 16 via a third plate 14, which is firmly connected to the output-drive part 16, on the end face facing the blocking bolt 5.

The third plate 14 is arranged in a recess in the blocking bolt 5 which is averted from the bolt, wherein the recess is designed such that the output-drive part 16 can move with the third plate 14, which is attached on the end face to the output-drive part 16, within the recess.

The recess is closed in the area of its opening by a stop 15 which has a central opening for the output-drive part 16. The stop 15 otherwise offers a contact surface for the third plate 14 of the output-drive part and therefore allows the axial movement of the output-drive part 16 to be transmitted to the blocking bolt 5, in the direction away from the bolt. The hollowed-out area in the blocking bolt 5 contains a further helical spring 7, which is located between the end-face third plate 14 and the bolt-side end of the recess.

That part of the blocking bolt 5 which surrounds the recess is broader than the output-drive part, and is broader than that part of the blocking bolt 5 which engages as a pin in the profile 3 on the bolt 2. The cross section of that part of the blocking bolt 5 which surrounds the recess in the illustrated embodiment rises in two steps, starting from the bolt-side end, which is in the form of a pin, of the blocking bolt 5. The step between a part of the blocking bolt of medium cross section and a part of the blocking bolt of the largest cross section is in this case used as an operating element for a limit switch 29b. A second limit switch 29a is operated by that end face of the blocking bolt 5 which is averted from the bolt 2.

The limit switches 29a, 29b are arranged at a distance from the blocking bolt 5, to the side of the movement axis of the blocking bolt 5, such that only the broadest part of the blocking bolt 5 makes contact with the limit switches 29a, 29b. The limit switches 29a, 29b are arranged further along the movement direction of the blocking bolt 5 such that the second limit switch 29a is activated when the blocking bolt 5 is in the pulled-back position, that is to say releases the bolt 2. In contrast, the first limit switch 29b is arranged such that it is activated as soon as the blocking bolt 5 engages in the profile 3 on the bolt 2, and therefore blocks the bolt 2. It is therefore possible to fix the position of the blocking bolt 5 reliably and independently of the position of the electrical input drive 18, of the output-drive part 16 or of the bolt 2. In FIG. 1, the limit switch 29b has been operated, signaling that the blocking bolt 5 is in the locked position.

In the illustrated embodiment, the limit switches 29a, 29b are located on a printed circuit board, which is fitted with a controller 10 formed by electronic components that are known per se. The controller 10 is held in an essentially rectangular housing and is located on the side which is averted from the electrical input drive 18, alongside the axis along which the threaded spindle, the output-drive part 16 and the blocking bolt 5 are moved. A battery compartment 27 for holding commercially available cylindrical batteries is also located, in addition to the controller 10, in the housing of the lock 1. Finally, the housing of the lock 1 also has two attachments 28a and 28b, which are in the form of holes for screws, rivets or similar attachment means.

FIG. 1 shows the lock 1 according to the invention in a state in which the bolt 2 is blocked, that is to say the blocking bolt 5 has engaged in the profile 3, and the intermediate element which comprises the output-drive part 16 including its end-face plates 15, 26 as well as the threaded spindle, is in the locked position. In the illustrated situation, both springs 7, 8 are in their unstressed position.

FIG. 2 shows the lock 1 according to the invention from FIG. 1, in the same view. In contrast to FIG. 1 the locking mechanism is in the open position in FIG. 2. In the open position, it is possible to pull back the bolt 2, as illustrated in FIG. 2. The pulled-back bolt 2 in FIG. 2 is not held completely in the housing of the lock 1. The bolt 2 can therefore be pulled back even further.

The blocking bolt 5 is in its non-locking position, as a result of which the profile 3 on the bolt 2 is released, and the bolt 2 can be moved freely. In order to move the blocking bolt 5 to this non-locking position, the threaded spindle is in its pulled-back position, that is to say it has been moved as far as possible to the right in the perspective illustrated in FIG. 2. The relative arrangement of the other elements of the locking mechanism is analogous to the arrangement shown in FIG. 1. In the position illustrated in FIG. 2, the blocking bolt 5 operates the limit switch 29a, which signals that the blocking bolt 5 is in the non-locking position, that is to say the lock can be opened.

The operation of the limit switches 29a, 29b is used to define the instantaneous position of the blocking bolt 5. This is useful on the one hand for monitoring and recording the closed situation of the respective lock 1, in particular for the purposes of a lock system comprising a plurality of locks. On the other hand, the operation of the limit switch 29a, which signals the non-locking position of the blocking bolt 5, defines the start of a time interval after which the threaded spindle is moved back again automatically by the input drive 18. Furthermore, it is possible to use the signal from one of the limit switches 29a, 29b relating to the position of the blocking bolt to produce an indication, for example a light-emitting diode, making it possible for the user to identify whether the lock is or is not locked.

In FIG. 2, as in FIG. 1 already, the two springs 7, 8 are in an unstressed position, that is to say neither of the springs 7, 8 is compressed.

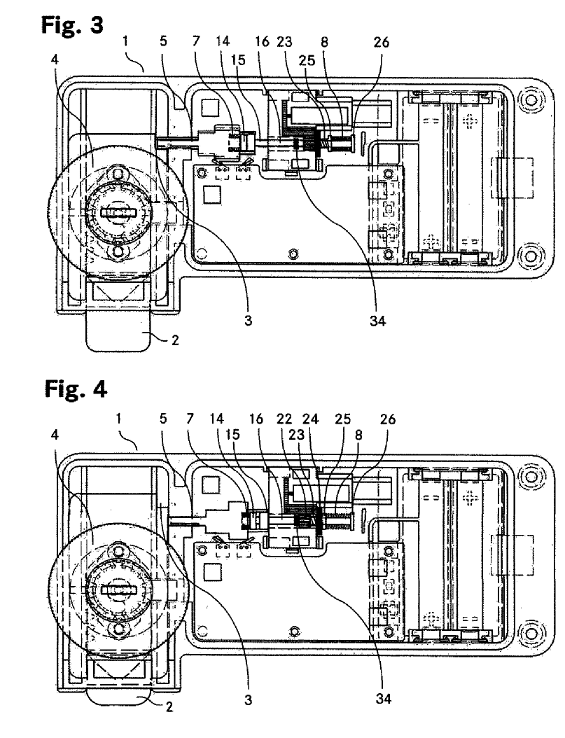

FIG. 3 shows the same lock 1 as in the two FIGS. 1 and 2. The blocking bolt 5 is in the locking position, that is to say it is engaged in the profile 3 on the bolt 2. However, in contrast to the situation illustrated in FIG. 1, in which the two springs 7, 8 are unstressed, the spring 8 is now stressed.

The threaded spindle is in the position for unlocking the lock 1. In this position, the threaded spindle has been pushed so far to the rear via the external thread 23 that the first plate 25 is exerting pressure on the spring 8. The spring 8 is compressed and itself exerts pressure on the second plate 26, and therefore on the output-drive part 16. The situation illustrated in this FIG. 3 can occur when the blocking bolt 5 is clamped in, for example by the user, pressing the bolt 2 against the blocking bolt 5. Since, in this case, the blocking bolt 5 cannot be moved freely, the opening movement of the threaded spindle leads to compression of the spring 8. As soon as the force which is clamping the blocking bolt 5 is released, the force of the spring 8 can transmit the movement of the threaded spindle to the output-drive part 16, moving the blocking bolt 5 to the non-locking position.

FIG. 4 shows a state of the lock in which the blocking bolt 5 is in the non-locking position. The bolt 2 has been pulled back such that the blocking bolt cannot engage in the profile 3 on the bolt 2. However, in the situation shown in FIG. 4, the threaded spindle is in the locking position. The threaded spindle transmits its movement through a stop ring 34 to the output-drive part 16. During this process, the output-drive part 16 is moved forward, together with the third plate 14, which is connected to it on the end face. As a result of its movement with the output-drive part 16, the third plate 14 exerts a force on the spring 7, as a result of which the latter is compressed between the blocking bolt 5 and the third plate 14 on the output-drive part. As soon as the blocking bolt 5 can engage in the profile 3 on the bolt 2, because the bolt 2 has been pushed forward again to its closed position, the spring 7 converts the force to a movement of the blocking bolt 5, and moves it to its locking position.

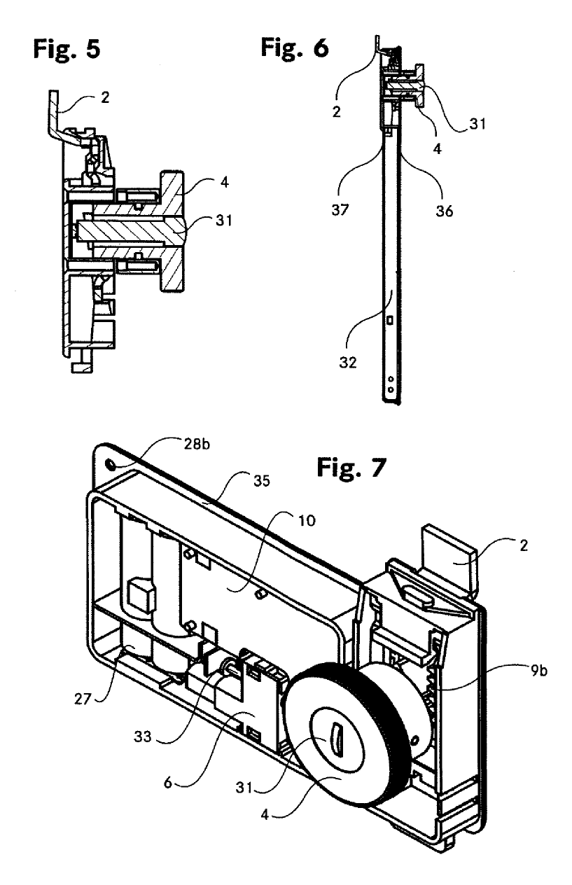

FIG. 5 shows a side view of a lock according to the invention, in the form of a cross-sectional illustration. The figure shows the rotating handle 4 and the pushbutton 31 which is accommodated centrally in the rotating handle 4 and extends from the surface of the rotating handle 4 to the bottom of the lock. At the bottom of the lock, the pushbutton 31 interacts with a contact element, as a result of which a signal can be initiated by operation of the pushbutton 32, initiating the unlocking process of the lock. As soon as the lock has been unlocked, the bolt 2 can be moved back by the rotating handle 4. As soon as an appropriate transponder is located in a reception area of the lock according to the invention, the unlocking process takes only a few fractions of a second after the pushbutton 31 has been operated.

FIG. 6 shows the lock according to the invention installed in a door 32 of a furniture item. The lock is incorporated in the door 32, between an outer wall 36 and an inner wall 37. The outer wall 36 and the inner wall 37 may, for example, be made of metal. In addition, it is also possible for the lock to be installed in a solid door 32 which has a recess shaped to correspond to the dimensions of the lock. The lock is positioned at the edge of the door 32, such that the bolt 2 of the lock projects beyond the otherwise straight edge of the door 32 when in its locking position, and interacts with a stop on the door 32 such that the opening of the door 32 can be blocked by the bolt 2. The bolt 2 of the lock, in the case of a door 32 which can be opened outward projects essentially as an extension of the inner wall 37 beyond the edge of the door 32. In the case of a door 32 which can be opened inward, the bolt 2 is formed analogously, essentially as an extension of the outer wall 36. In addition, it is also feasible for the bolt 2 to be arranged as an extension of both the outer wall and of the inner wall 36, 37, or in a depression between the walls 36, 37 of the door. As already shown in FIG. 5, FIG. 6 also shows a side view of the lock and of the door 32 in the form of a cross-sectional illustration. The lock is essentially of the same thickness as the door 32 of the furniture item, and can therefore be recessed in the door 32. Like FIG. 5, FIG. 6 also shows the rotating handle 4 of the lock in the form of a cross section and the pushbutton 31, which extends along the rotation axis of the rotating handle 4 from the surface of the rotating handle to the bottom of the lock. When the lock is in the unlocked state, the bolt 2 can be pulled back by means of the rotating handle 4.

FIG. 7 shows a perspective drawing of a lock according to the invention. The elements which have also already been illustrated in the previous FIGS. 1 to 4 are mounted on a bottom plate 35. The filled accommodation compartment for batteries 27 is shown in the left-hand part of the figure. The controller 10 for the locking mechanism is located alongside this, on the right, in the upper part of the housing of the lock. The electrical actuator 6 is illustrated underneath the controller 10. In the embodiment illustrated here, the actuator 6 comprises a rotary electric motor and a transmission, which converts the rotary movement of the motor to a linear movement of the intermediate element 33. The intermediate element 33 runs from left to right in FIG. 7, and drives a blocking bolt which, in its locking position, blocks the bolt 2 of the lock. The bolt 2 of the lock is connected via a toothed rod 9b and a gearwheel to a rotating handle 4, via which it can be moved manually. A pushbutton 31 is located in the center of the rotating handle 4 and is pushed in order to operate the locking mechanism. The bolt 2 and the rotating handle 4 of the lock are arranged on the right-hand side of the lock, in the embodiment of the lock illustrated in FIG. 7. The rotating handle 4 is in the form of a round hand wheel which is fitted above the housing of the lock and is provided with circumferential fluting, which makes it easier to operate the rotating handle 4. FIG. 7 furthermore shows an attachment 28b in the bottom plate 35, by means of which the lock can be attached to a door of a furniture item. Overall, the lock has an essentially rectangular shape which can be appropriately adapted to the arrangement of the individual components of the lock. The small extent of the lock at right angles to the alignment of the bottom plate allows the lock to be conveniently incorporated in doors or wall elements of a furniture item.

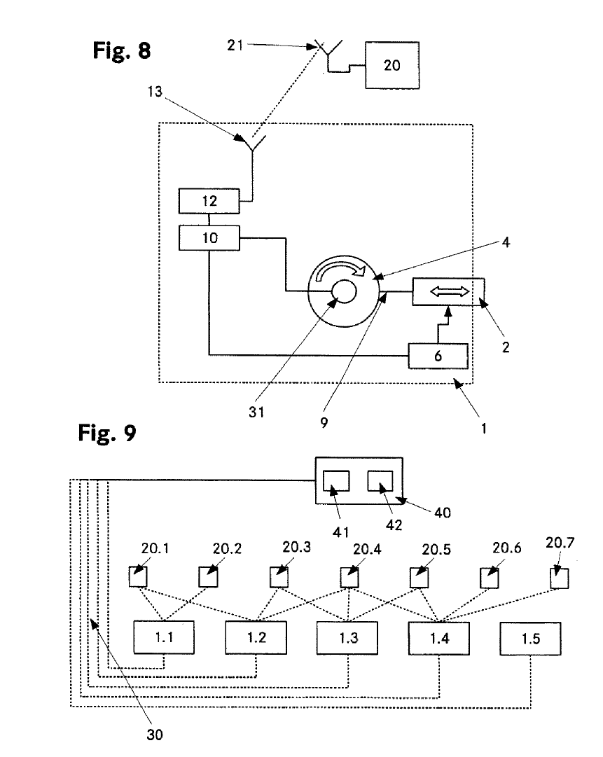

FIG. 8 shows a block diagram of a lock according to the invention, and its communication with a transponder. The lock 1 may, for example be designed according to one of the embodiments described above. It comprises a bolt 2 and a rotating handle 4, by means of which the bolt 2 can be operated via a coupling mechanism 9, in order to lock and to unlock the lock. Furthermore, an actuator 6 is provided in the lock 1, and can block the bolt 2. The actuator is controlled by a central controller 10, which is connected to a pushbutton 31 and to a transmitter/receiver 12. An antenna 13 is coupled to the transmitter/receiver 12. The controller 10 and the transmitter/receiver 12 can be accommodated in the bolt housing, in the actuator housing or in a further housing of the lock 1. By way of example, the antenna may be provided in the area of the rotating handle 4, so as to ensure communication without interference with the area outside the furniture item. The lock 1 can be opened with the aid of an active transponder 20, which is likewise provided with an antenna 21.

The procedure for an opening process for the described embodiment will be described in the following text. The transponder 20 is controlled such that it is generally in a standby state, in which the transponder 20 itself does not emit any signals; its receiver is simply in standby. This makes it possible to save energy. The transponder is activated to emit signals itself via the antenna 21 by means of a transmitter only when signals of a predetermined type and with a predetermined data content are received via the antenna 21. These signals are in a predetermined form (frequency, amplitude, modulation) and have a predetermined data content and, in particular, comprise identification information for the transponder 20.

The lock 1 is generally also in a standby state. In this state, the transmitter/receiver 12 is switched off, and the actuator 6 is not live. The lock 1 is switched to the operating state, for example via the pushbutton 31 and via the controller 10. In the operating state, the transmitter/receiver 12 regularly emits activation signals for the transponder 20, monitored by the controller 10; at the same time, the transmitter/receiver 12 is also ready to receive signals from transponders 20.

When the user equipped with the transponder 20 approaches the furniture item with the lock 1, there is therefore first of all no communication between the lock 1 and the transponder 20. As soon as the user operates the pushbutton 31, however, the lock 1 is switched to its operating state. An activation signal is therefore emitted, and is received by the transponder 20. This is thus activated to emit its identification signal, which can then in turn be received by the transmitter/receiver 12 in the lock 1.

If the identification information contained in the identification signal from the transponder 20 matches the identification data stored in the controller 10, the controller 10 activates the actuator 6, as a result of which the actuator 6 releases the bolt 2, as a result of which the lock 1 can be unlocked by operating the rotating handle 4. The switching of the lock 1 to the operating state, the activation of the transponder and the interchange of the identification information take place within a very short time, such that the actuator 6 will have already been operated by an appropriate transponder 20 when the user wishes to turn the rotating handle 4. The user therefore does not suffer from any lack of convenience, since both the transponder 20 and the lock 1 are in general in their power-saving standby mode.

The identification information can be fed into the controller 10 in various ways. In the simplest case, it is already stored there by the manufacturer, for example in a read only memory; the transponders are then provided with the information corresponding to the locks to be opened. If the locking plan changes, the changes are therefore carried out at the transponder level. However, the lock can also be designed such that the identification information can also be programmed or changed retrospectively, for example by means of wire-free transmission via the antenna 13 and the transmitter/receiver 12. Furthermore, it is also possible to check the identification information on line in a central database during each opening process, and the existing transmitting/receiving means can likewise be used for this purpose.

Once the bolt 2 has been released, a time interval starts which can be determined on a general basis or individually for each individual lock, after the end of which the actuator 6 is once again moved to the position in which the bolt 2 is blocked. The time interval is typically 2 to 3 seconds. Within the time interval between the release of the bolt 2 and the actuator 6 being moved back, the rotating handle 4 can be operated, and the lock 1 can thus be opened. Because of the configuration of the blocking mechanism according to the invention, and as illustrated in FIGS. 1 to 4, the actuator 6 can be moved back to the blocking position even when the bolt 2 is not yet in its closed position. This is because, in this situation, the helical spring 7 is prestressed, such that the blocking bolt 5 can latch into the corresponding depression after manual locking of the lock. After the time interval and after the actuator 6 has moved back, the lock can once again change to its power-saving standby mode.

FIG. 9 shows a block diagram of a furniture system having a lock installation according to the invention. The system comprises a plurality of furniture items, each having a lock 1.1 . . . 1.5 as illustrated in FIG. 8. The locks 1.1 . . . 1.5 interact with a series of transponders 20.1 . . . 20.7, in which case flexible locking plans can be used, in the course of which the access to the locks 1.1 . . . 1.5 for each transponder 20.1 . . . 20.7 can be released or blocked as required. The locks 1.1 . . . 1.5 communicate via a network 30 with a central controller 40. In particular, the network 30 is in wire-free form, for example, controls the transmitting and receiving means provided in the locks 1.1 . . . 1.5. The central controller 40 on the one hand has an authorization database 41, in which associations between identification codes and authorizations for opening the locks 1.1 . . . 1.5 can be stored, thus allowing central management of the authorizations. The authorization information that is relevant for the individual locks 1.1 . . . 1.5 can in each case be checked on line by the locks 1.1 . . . 1.5 via the network 30 with the central controller 40, or it is stored in the locks 1.1 . . . 1.5 and is updated as required by the central controller 40 via the network 30. The entire locking plan can thus be managed and adapted centrally without the transponders 20.1 . . . 20.7 having to be replaced or reprogrammed.

On the other hand, the central controller 40 has an access database 42, in which the appropriate time and the identification of the transponder 20.1 . . . 20.7 used are stored for each opening process carried out in one of the locks 1.1 . . . 1.5. Based on this data, it is possible subsequently to find out, for example, which user has operated a specific lock at what time, and how often. Further information can be obtained from the data gathered, by statistical methods. All of this information can be used in a further step for optimization of the working environment of the users of the furniture system, for example to shorten movement distances for the users or to position furniture items which are used frequently by the same user at short time intervals, closer together.

Different design embodiments of the lock according to the invention are also feasible. For example, the lock can be made less flat by arranging individual components of the lock differently with respect to one another. For example, it is possible to use different batteries, which reduce the extent of the lock. In addition to an electrical input drive in the form of a rotating motor, it is also possible to use a linear actuator, which acts on the threaded spindle and a blocking bolt via an appropriately adapted transmission. In addition to being in the form of a recess at one corner of the bolt, the profile can also be designed differently, for example by a projection in the form of a tab, which blocks movement of the bolt when the blocking bolt is in the locking position. In addition to a blocking bolt, which engages axially in a profile on the bolt, it is also possible to use a blocking element which can pivot, and can be moved by the output-drive part to a locking or non-locking position. In addition to helical springs, it is furthermore also possible to use other sprung elements.

In summary, it can be stated that the invention provides a mechatronic lock which is of simple design and can be controlled and used largely in the same way as conventional mechanical locks.

1. A mechatronic lock, in particular a furniture lock, having
a) a linearly moving bolt which can be moved from a pulled-back position to a pushed-forward position in order to lock the lock;
b) an operating element for manual operation of the bolt;
c) a blocking element which can engage at the side in a profile on the bolt in order to block the linear movement of the bolt in the pushed-forward position of the bolt;
d) an electrical input drive for movement of a moving intermediate element;
wherein
e) the blocking element can be operated via a first spring element, in particular via a helical spring, by the moving intermediate element such that the spring element can be prestressed by operation of the input drive with the bolt pulled back, such that, when the bolt is pushed forward to its pushed-forward position, the blocking element snaps into the profile on the bolt, and prevents the bolt from being pulled back;
f) the intermediate element comprises an input-drive part which can be moved by operation of the input drive, and an output-drive part, which is mounted on the input-drive part via a second spring element, such that the second spring element is stressed by operation of the input drive when the blocking element is jammed in the profile on the bolt by pulling the blocking element back when the bolt is released; whereas
g) the input-drive part and the output-drive part of the intermediate element, the blocking element as well as the first and the second spring elements are arranged on the same axis;
h) a compression spring is arranged as the second spring element arranged on a side of the input-drive part facing away from the blocking bolt, whereas a force transmission in a first direction, which is used to unlock the lock, takes place via the compression spring, a movement of the input-drive part leading to pressure being applied to the compression spring, which passes the pressure onto the output-drive part;
i) when moved in a direction opposite the first direction, the input-drive part acts on a stop ring, which transmits the movement directly to the output-drive part, whereas the output-drive part presses on the first spring element, which thus exerts force on the blocking bolt.

2. (canceled)

3. The lock as claimed in claim 1, characterized in that the input drive is formed by an electric motor having a rotating shaft, and in that the intermediate element can be moved by rotation of the rotating shaft via a transmission.

4. The lock as claimed in claim 3, characterized in that the input-drive part of the intermediate element is a threaded sleeve, which interacts with a profiled output shaft of the transmission via an external profile which is connected in a rotationally fixed manner thereto.

5. The lock as claimed in claim 1, characterized in that the blocking element is formed by a linearly movable blocking bolt.

6. (canceled)

7. The lock as claimed in claim 3, characterized in that the output-drive part is guided movably in the threaded sleeve and extends from that side of the threaded sleeve which faces away from the blocking bolt to that side of the threaded sleeve which faces the blocking bolt, in that the compression spring is arranged between the threaded sleeve and an end of the output-drive part facing away from the blocking bolt, in that the stop ring is arranged between the threaded sleeve and an end of the output-drive part which faces the blocking bolt.

8. The lock as claimed in claim 1, characterized in that the operating element can be rotated for operation of the bolt.

9. The lock as claimed in claim 8, characterized in that the operating element is coupled to the bolt by a toothed-rod input drive, wherein the toothed-rod input drive is formed by a first gearwheel-like tooth system on the operating element side and by a toothed-rod-like tooth system which permanently interacts therewith and is on the bolt side.

10. The lock as claimed in claim 1, characterized in that the lock can be opened only when an appropriately coded transponder is moved into a reception area of the lock.

11. The lock as claimed in claim 10, characterized by a transmitter which can emit an activation signal in order to activate an active transponder to emit an identification signal.

12. The lock as claimed in claim 10, characterized by a control element, in particular a pushbutton, using which the transmitter can be activated to emit the activation signal or to read passive transponders.

13. The lock as claimed in claim 12, characterized in that the operating element can be rotated for operation of the bolt and that the control element is in the foam of a pushbutton which is arranged in a rotating shaft of the rotatable operating element.

14. The lock as claimed in claim 1, characterized by a controller which controls the lock such that the electrical input drive is operated automatically after a predetermined time interval after an opening process of the blocking element, such that, depending on the position of the bolt, the blocking element is moved forward and the first spring means element is stressed.

15. The lock as claimed in claim 1, characterized in that the lock is provided with sensors sing which an instantaneous position of the blocking bolt can be detected.

16. The lock as claimed in claim 1, characterized in that the electrical input drive is supplied with electrical power by a battery.

17. The lock as claimed in claim 16, characterized in that the lock comprises a device for measurement of a battery voltage, and in that the lock is controlled such that an alarm signal is sounded when a predetermined first battery voltage is undershot, and that, after undershooting a predetermined second battery voltage, which is lower than the first battery voltage, the lock can then be opened only by a specifically coded transponder.

18. A furniture item having at least one lock as claimed in claim 1.

19. The furniture item as claimed in claim 18, characterized in that the lock is held between an outer wall and an inner wall of a door of the furniture item.

20. An arrangement comprising
a) at least two furniture compartments, wherein each of the furniture compartments comprises at least one mechatronic lock, in particular a lock as claimed in claim 1;
b) at least two transponders for opening the locks, wherein a first identification code can be allocated to a first of the transponders, and a second identification code which is not the same as the first identification code, can be allocated to a second of the transponders;
c) a central control device;
d) a network via which data can be transmitted between the central control device and the locks.

21. The arrangement as claimed in claim 20, characterized in that the central control device comprises an authorization database, in which associations between identification codes and authorizations for opening the locks can be stored, thus allowing central management of the authorizations.

22. The arrangement as claimed in claim 20, characterized in that the central control device comprises an access database, in which associations between identification codes and opening processes of the locks can be stored, so as to allow evaluation of the opening movements with respect to a plurality of users.

23. A method for detection of the use of a working environment which has at least two furniture compartments, wherein each of the furniture compartments comprises at least one mechatronic lock, in particular a lock as claimed in claim 1, wherein the method comprises the following steps:
a) issuing of transponders for opening the locks to users of the working environment, wherein different identification codes are allocated to different transponders;
b) during opening processes, detection of the respective identification code by the respective mechatronic lock;
c) sending the identification code to a central database;
d) storage of the association between a lock and an identification code in the central database.
